(19) United States
(12) Patent Application Publication
(10) Pub. No.: US 2009/0048719 A1
(43) Pub. Date: Feb. 19, 2009

(54) Environmental Temperature Control System

(75) Inventors: Dermot McLaughlin, Cookstown (GB); Joseph Bradley, Cookstown (GB)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(73) Assignee: MAGMA HEAT LIMITED, Cookstown, County Tyrone (GB)

(21) Appl. No.: 12/092,435

(22) PCT Filed: Nov. 6, 2006
(86) PCT No.: PCT/GB06/04119

§ 371 Date: May 2, 2008

(30) Foreign Application Priority Data
Nov. 4, 2005 (GB) 0522565.1

(51) Int. Cl. G05D 23/00; G05D 23/19

(52) U.S. Cl. 700/299; 236/51; 236/46 R

(57) ABSTRACT

An environmental temperature control system comprises one or more thermostats (10). The or each thermostat is integrated into an electronic control circuit having an external temperature sensor means (12), with a floor temperature sensor means (14) and a room ambient temperature sensor means (16) provided for the or each thermostat. All of the temperature readings from the sensor means in the or each thermostat are intended to be fed to a processing means to control the floor temperature of an underfloor heating system in one or more rooms or areas of a building.

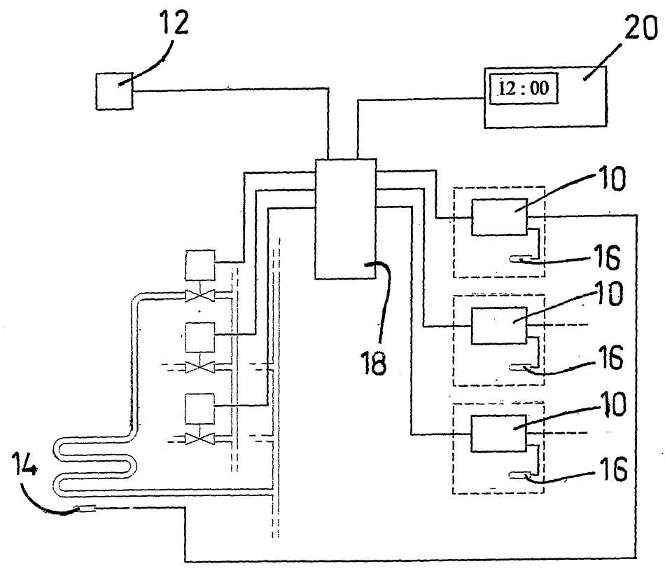

This invention relates to an environmental control system and in particular to a system for weather compensation for use with underfloor heating of either a warm water type or an electrical type.

Heretofore, under floor heating solves a major problem with space heating by providing an even balanced heating effect at low temperature. Draughts are eliminated, heat is evenly spread throughout the room, fuel consumption is reduced and there is an increased perception of comfort compared to in-room radiator heating systems.

Control of the floor temperature is central to achieving the required comfort effect and should vary according to an outside temperature. The maximum floor temperature permissible is regulated within the EEC to prevent health related problems.

The rate of heat loss from a building is related to the perceived temperature difference between the inside of the building and the outside. Therefore more heat has to be inputted into the building in cold weather than in warm weather to be able to maintain the same internal temperature. When the weather is cool, maximum comfort levels are achieved if the floor temperature is high, close to the regulatory limits. This high floor temperature is also necessary to ensure ideal reaction times so that the rate of reaction of the system is not sluggish due to the high heat losses.

However these same high floor temperatures can be uncomfortable during warmer weather and will also result in increased fuel consumption and in increased overshoot of the user set point temperature.

Electrical under floor heating systems and some current warm water systems ignore this problem and make no provision for changing the floor temperature dependent on the external temperature. Other systems utilise a weather compensation system that is a legacy from radiator type heating. They process the signal from a remote temperature sensor and accordingly alter the water temperature to the heating system as a whole and thus of the under floor heating coils. This can be called a broad brush effect.

However with this broad brush effect, there is no way to know to what extent this system works since there is seldom any feedback from the individual floors and there could well be times, especially when rooms are being brought back up to a required temperature, when the regulatory floor temperature limits are being breached and/or required comfort levels are not achieved. Any temperature feedback there is from individual floors is not looped back into the control system to adjust the floor temperature up and down but used purely to ensure that the supply to the floor is shut off if the regulatory floor temperature has been breached.

In fact, in existing systems, it is not possible to use the floor temperature sensor in any other way, since weather compensation data is only available for control of overall water temperature centrally and is not available at the individual thermostat and room control level. Some of these systems may use the room temperature from a master room to regulate the water temperature to the whole system, but without extremely accurate calculations, data figures and room balancing, some floors will still receive too much heat while others may receive insufficient. Even if there was very accurate balancing of the heating load to the rooms, and exact balancing is generally not possible due to the numerous assumptions that have to be made for the calculations, there would still be problems with this system since the response of the heating system will be sluggish if there is reduced water temperature and a number of rooms are drawing heat at the same time.

The end result required is to control the floor temperature. The bottom line is that under present arrangements a person can never reliably know or control the floor temperature by controlling an intermediate step (i.e. the water temperature).

Current thermostats control the room temperature using either the ambient temperature or the floor temperature.

Ambient temperature gives the swiftest reaction to temperature change and can provide the most accurate control in relation to the set point. However ambient temperature measurements are susceptible to draughts due to doors and windows being opened and to the effects of sunlight streaming through windows. Since ambient temperature can vary rapidly, ambient control can result in excessive fuel usage, dependent on the thermostat differential.

Draught cause additional heat energy to be input to the room where it is not necessarily needed so wasting energy and causing overshoots on the set temperature. Streaming sunlight, especially when the sunlight is affecting the wall in the area of the thermostat, fools the heating system into believing that the room is warmer than it actually is.

Floor sensors, on the other hand, do not react to localised temperature changes such as draughts and streaming sunlight and so are more energy efficient. However they are sluggish to react to genuine temperature changes resulting in discomfort over prolonged periods.

An object of the present invention is to obviate or mitigate the above problem.

Accordingly, the present invention is an environmental temperature control system comprising one or more thermostats, the or each being integrated into an electronic control circuit having an external temperature sensor means, with a floor temperature sensor means and a room ambient temperature sensor means provided for the or each thermostat, all of whose temperature readings are intended to be fed to a processing means to control the floor temperature of an underfloor heating system in one or more rooms or areas of a building.

Preferably, an external temperature sensor means is provided for each thermostat.

Preferably also, a time clock is integrated into the circuit. The time clock may desirably be digital.

An embodiment of the present invention will now be described, by way of example, with reference to the accompanying drawing which shows a block circuit diagram of an environmental temperature control system used with a warm water type underfloor central heating.

Referring to the drawing, an environmental temperature control system comprises one or more thermostats 10. The or each thermostat 10, three are shown in the drawings, is integrated into an electronic control circuit having an external temperature sensor means 12, with a floor temperature sensor means 14 and a room ambient temperature sensor means 16 provided for each thermostat, all of whose temperature readings are intended to be fed to a processing means 18 to control the floor temperature of an underfloor heating system in one or more rooms or areas of a building. The room ambient temperature sensor means 12 normally is provided in the thermostat 10 as shown.

A digital time clock 20 is integrated into the circuit.

Temperature stability (ambient temperature) to +/−½° Centigrade from a temperature set point. If necessary, an intelligent learning mode will be used to achieve this.

For setback (time clock off, temperature stabilises at a temperature 4° lower (setback temperature) than the set point. This allows the temperature to be rapidly returned to normal when the time clock reactivates.

Each thermostat controls both the room temperature and the floor temperature. The main control is the ambient sensor but the floor sensor is monitored to ensure that the floor temperature does not exceed the regulatory limits. Should the floor temperature reach the maximum regulatory limits, heating of the floor will cease until the temperature has lowered again. The maximum floor temperature will be 28° Centigrade.

In addition to ensuring that regulatory limits are complied with and a healthier environment provided, an added benefit of also monitoring the floor temperature is that overshoot in the ambient temperature will be reduced, resulting in reduced fuel costs.

The system has multiple independent weather compensation for each thermostat. The external air sensor signals the outside temperature to the individual room thermostats. The maximum floor temperature of each room will be altered depending on the external temperature. When the external temperature is 0° Centigrade or below, the maximum floor temperature of 28° Centigrade will apply. For an external temperature of 20° Centigrade or above a floor temperature of 2° Centigrade above the set point will apply. A linear model is used to determine the required floor temperature for external temperatures between 0 and +20° Centigrade.

Use of multiple independent weather compensation provides improved comfort and reduced fuel consumption.

When weather compensation is invoked, the setback temperature difference will be altered as follows to provide fuel savings while still maintaining a fast return to set-point temperature:

| External Temperature | Setback Temperature |
|---|---|
| Below 5° | 3° Centigrade |
| 5° to 10° | 4° Centigrade |
| 10° plus | 5° Centigrade |

The weather compensation is provided by a remote sensor housed outside in a totally enclosed box. It is anticipated that the temperature in the box will change sufficiently quickly with ambient that ventilation slots will not be required.

A circuit board for the weather compensation thermostat is housed in the main controller as an add-on board. This switch is a 3 position rotary switch on the front of the thermostat. The left position is “Setback”, the middle position “Clock” and the right position “Always On”.

A green indicator, such as a LED, is provided to illuminate continuously when the thermostat is on; i.e. either “always on” mode or in the “time clock on” cycle. When the thermostat is in setback the green indicator will be off. A red or orange indicator, such as a LED, is provided to illuminate continuously when heat is being added to the floor. This will occur when the combination of set point, floor and room sensors determines that additional input is required. The red or orange indicator is configured to flash to indicate the presence of a faulty floor sensor, room sensor, set-point switch or calibration resistor. The rate of flashing will differentiate the fault detected. This flashing will occur continuously when heat is being transferred to the floor and for 10 seconds in every 20 seconds at other times, even when the time clock is off. The thermostat operates at 230 volts AC, however the thermostat is designed such that by removal of one or at most two components and fitting a wire link, it can be converted to 24 volts AC or DC. This will allow one printed circuit board to do all.

By moving a switch accessible on the lower side of the circuit board and attaching a remote sensor cable to a terminal block on the back plane, the ambient sensor can be isolated and the unit adapted to control the temperature in a remote location.

Although the thermostat has a dual sensor ability (room and ambient sensors) it will also operate with ambient sensor only or floor sensor only.

Each thermostat incorporates a 12-way switch with fixed resistors to set temperature points monitored by a microcontroller. Each thermostat is configured so as not to react to sudden draughts brought about by the opening or closing of a door or window to provide the optimum mix of control and fuel consumption using intelligent floor sensor control with the room temperature over-ride. The thermostat is designed such that, with minimal modification/component changes, the circuit board can be upgraded for use in a future networked environment where thermostats report back to a central control unit allowing temperature information to be accessed via the Internet.

This product application seeks to address the shortcomings of the current system by introducing the concept of multiple independent weather compensation for each room. Rather than control the water temperature to attempt to achieve control of the floor temperature, this intermediate step is removed. Water temperature is maintained constant at a suitably high level, and there is dedicated control of the actual floor temperature in each room. The system is equally suitable for electrical under floor heating with the valve means being replaced by direct or indirect actuation of the electrical under floor heating mat.

The reading from an external air temperature sensor means is processed by a processing means and a digital or analogue signal will convey the outside temperature information to any number of individual room thermostats via a control line. This control line may be an existing cable used for other functions (such as the time clock signal), allowing the system to be retrofitted where alternative systems have already been installed. The control line may also be used for feedback of information/data from the individual thermostats to a central processing unit from which it could be uploaded by a modem or other means to a computer or other data monitoring system. The system may be used with or without a time clock.

Each thermostat has attached or incorporated two or more temperature sensor means, the first measuring the ambient air temperature within the room and the second measuring the temperature of the floor. Multiple sensors could be used for both the internal ambient and floor sensor means. The external air temperature sensor means and the processing means could be combined as one or could be two different units either free standing or incorporated with other elements of the heating system or the house electrical system. The temperature sensor means could be a thermistor, a thermocouple, a platinum resistor sensor or other.

For warm water types of underfloor heating, the flow of water will be regulated on and off via a valve means (as happens with the majority of thermostats) in order to maintain the internal ambient temperature selected by a user set point and measured by the ambient air sensor means. Alternatively the flow of water would not be shut off but would be variably controlled by the valve means to achieve the required end result. Similarly an under floor heating mat would be controlled on and off (or partially on) by the thermostat.

Where this application differs from existing systems is that additional control is effected by feedback from the floor temperature sensor means. For the initial variant the floor temperature would be regulated to a maximum level that would be depend ant on the external temperature and/or the difference between the measured external temperature and the measured floor temperature.

A linear algorithm, an exponential algorithm or any one of a number of other algorithms could be used to determine the maximum floor temperature for various sets of circumstances. This control would act as an over-ride on the internal ambient sensor control and would shut off the heat to the floor if the floor temperature achieved the maximum allowable thus determined. Hence in cold weather the maximum floor temperature allowable would be quite high while in warm weather the maximum floor temperature allowable would be much lower.

A further variant will record its actions and temper the algorithms using its previous history to achieve optimum achievement of the set point temperature with almost zero overshoot and even greater fuel efficiency. This variant may also record time clock on/off periods and anticipate the optimum time to commence bringing the floor back to temperature prior to the time clock activation.

The processing power in the thermostat and elsewhere in the system could be a microcontroller, microprocessor, fpga (field programmable gate array), asic (application specific integrated circuit) or discrete digital or analogue circuitry. The thermostat and ancillary equipment may be operated from either 230 volts AC supply, from a low voltage AC or DC supply or from batteries or solar power.

In a first modification, the system uses the ambient sensor for control for the warm-up period and after temperature has stabilised, resorts to floor sensor control, using the floor temperature parameters established at stabilisation during the start up period. Should external factors case the floor sensor operation to get out of sync with requirements, room sensor override will kick in after a short period of re-establishment the optimum parameters. This provides a very stable and very fuel-efficient operation and a great degree of comfort as comfort perception depends on both the floor temperature and the actual room temperature

In a second modification, an external temperature sensor means is provided for each thermostat.

In a third modification, the system has a switch facility for Constant Setback or Always On.

Variations and other modifications can be made without departing from the scope of the invention described above and as claimed hereinafter.

1. An environmental temperature control system comprising an electronic control circuit for a building having one or more rooms or areas where temperatures are to be controlled, the circuit having an external temperature sensor integrated therewith and also having integrated therewith per each room or area a thermostat to receive temperature readings from a floor temperature sensor means and a room ambient temperature sensor means, both located in the respective room or area, whereby temperature readings from each sensor means are fed to a processing means to control the temperature in the or each individual room or area.

2. An environmental temperature control system as claimed in claim 1, wherein an external temperature sensor means is provided for each thermostat.

3. An environmental temperature control system as claimed in claim 1, wherein a time clock is integrated into the circuit.

4. An environmental temperature control system as claimed in claim 1, wherein a multiple independent weather compensation for the or each thermostat is provided to give comfort and reduce fuel consumption the weather compensation being provided by a remote sensor housed externally.

5. (canceled)

6. An environmental temperature control system as claimed in claim 1, wherein each thermostat incorporates two or more temperature sensor means, the first being to measure the ambient temperature within the room and the second measuring temperature of the floor.

7. A method of controlling environmental temperature by way of the control system as claimed in claim 1.

8. (canceled)

9. An environmental temperature control system as claimed in claim 2, wherein a time clock is integrated into the circuit.

10. An environmental temperature control system as claimed in claim 2, wherein a multiple independent weather compensation for the or each thermostat is provided to give comfort and reduce fuel consumption, the weather compensation being provided by a remote sensor housed externally.

11. An environmental temperature control system as claimed in claim 3, wherein a multiple independent weather compensation for the or each thermostat is provided to give comfort and reduce fuel consumption, the weather compensation being provided by a remote sensor housed externally.

12. An environmental temperature control system as claimed in claim 10, wherein a time clock is integrated into the circuit.

13. An environmental temperature control system as claimed in claim 2, wherein each thermostat incorporates two or more temperature sensor means, the first being to measure the ambient temperature within the room and the second measuring temperature of the floor.

14. An environmental temperature control system as claimed in claim 3, wherein each thermostat incorporates two or more temperature sensor means, the first being to measure the ambient temperature within the room and the second measuring temperature of the floor.

15. An environmental temperature control system as claimed in claim 4, wherein each thermostat incorporates two or more temperature sensor means, the first being to measure the ambient temperature within the room and the second measuring temperature of the floor.

16. An environmental temperature control system as claimed in claim 10, wherein each thermostat incorporates two or more temperature sensor means, the first being to measure the ambient temperature within the room and the second measuring temperature of the floor.

17. An environmental temperature control system as claimed in claim 11, wherein each thermostat incorporates two or more temperature sensor means, the first being to measure the ambient temperature within the room and the second measuring temperature of the floor.

18. An environmental temperature control system as claimed in claim 12, wherein each thermostat incorporates two or more temperature sensor means, the first being to measure the ambient temperature within the room and the second measuring temperature of the floor.

19. The method of controlling environmental temperature as recited in claim 7, comprising the steps of:
(a) sending an signal representative of a detected external temperature from an external temperature sensor to an electronic control circuit for a building having one or more rooms or areas where temperatures are to be controlled;
(b) providing to the electronic control circuit a floor temperature signal representative of a floor temperature detected by a floor temperature sensor means in a respective one of the rooms or areas;
(c) providing to the electronic control circuit a room ambient temperature signal representative of a room ambient temperature detected by a room ambient temperature sensor means in the respective one of the rooms or areas; and
(d) controlling the temperature in the respective one of the rooms or areas in response to the temperature signals provided to the control circuit, which temperature signals are evaluated by a processor means.
